(19) United States
(12) Patent Application Publication
(10) Pub. No.: US 2026/0117741 A1
(43) Pub. Date: Apr. 30, 2026

(54) MOUNTING ARRANGEMENT FOR A WIND TURBINE

(71) Applicants: ZF FRIEDRICHSHAFEN AG, Friedrichshafen (DE); ZF Wind Power Antwerpen N.V., Lommel (BE)

(72) Inventor: Arno KLEIN-HITPASS, Aachen (DE)

(21) Appl. No.: 19/370,856

(22) Filed: Oct. 28, 2025

(30) Foreign Application Priority Data
Oct. 30, 2024 (DE) 10 2024 210 467.1

(51) Int. Cl. F03D 1/00; F03D 13/10; F03D 80/70; F03D 80/80

(52) U.S. Cl. CPC F03D 1/141; F03D 13/122; F03D 80/703; F03D 80/881

(57) ABSTRACT

A mounting arrangement for mounting a drive train on a tower of a wind turbine includes a bedplate mounted on the tower and a main bearing unit. The main bearing unit rotatably supports a rotor shaft of the drive train and radial forces of the rotor shaft. The radial forces include components in a horizontal transverse direction perpendicular to the rotor shaft axis and in a vertical direction perpendicular to the rotor shaft axis and to the horizontal transverse direction. A support housing accommodates and supports components of the drive train, and an auxiliary bearing unit supports the support housing. Coupling elements support the main bearing unit and/or the auxiliary bearing unit on the bedplate. Each coupling element is configured as a rod link which is rotatably mounted at both ends and has a greater rigidity in its longitudinal direction than transverse to its longitudinal direction.

### CROSS REFERENCE TO RELATED APPLICATIONS

This application claims benefit to German Patent Application No. DE 10 2024 210 467.1, filed on Oct. 30, 2024, which is hereby incorporated by reference herein.

### FIELD

The present disclosure relates to a mounting arrangement for a wind turbine. The present disclosure also relates to a wind turbine that includes the mounting arrangement.

### BACKGROUND

Wind turbines are known that serve to generate electricity from wind energy through conversion. For conversion, a rotor is provided in such plants, which is designed to convert wind energy into a mechanical power, for example, into a rotation with a torque. The torque generated in this way can be fed into a drive train in order to be converted into electrical power, for example by a generator. Due to the large weights and forces that occur, for example, in large wind turbines with an output of several megawatts, high demands are placed on the mounting of the drive train with regard to load capacity and vibration response. In view of these requirements, solid, highly rigid housings are used to accommodate and support the drive train, which can result in a high weight.

### SUMMARY

In an embodiment, the present disclosure provides a mounting arrangement for a wind turbine for mounting a drive train on a tower of the wind turbine. The mounting arrangement includes a bedplate that is mounted on the tower. The mounting arrangement unit also includes a main bearing unit for rotatably supporting a rotor shaft of the drive train and for supporting radial forces of the rotor shaft, the radial forces with respect to a rotor shaft axis having components in a horizontal transverse direction perpendicular to the rotor shaft axis and in a vertical direction perpendicular to the rotor shaft axis and to the horizontal transverse direction. The mounting arrangement includes support housing for accommodating and supporting components of the drive train, and an auxiliary bearing unit for supporting the support housing. The mounting arrangement includes two or more coupling elements for supporting at least one of the main bearing unit and the auxiliary bearing unit on the bedplate, and each coupling element is configured as a rod link which is rotatably mounted at both of its ends and has a greater rigidity in its longitudinal direction than transverse to its longitudinal direction.

### BRIEF DESCRIPTION OF THE DRAWINGS

Subject matter of the present disclosure will be described in even greater detail below based on the exemplary figures. All features described and/or illustrated herein can be used alone or combined in different combinations. The features and advantages of various embodiments will become apparent by reading the following detailed description with reference to the attached drawings, which illustrate the following:

FIG. 1 is a schematic view of a wind turbine including a drive train, according to an embodiment of the present disclosure;

FIG. 2 is an illustration of a basic principle for supporting forces and moments of the wind turbine of FIG. 1, according to an embodiment of the present disclosure;

FIG. 3 is a view illustrating a bending of a rotor shaft of the wind turbine of FIG. 1, according to an embodiment of the present disclosure;

FIG. 4 is a schematic perspective view of a mounting arrangement according to an embodiment of the present disclosure;

FIG. 5 is a schematic view showing coupling elements of the mounting arrangement of FIG. 4, according to an embodiment of the present disclosure;

FIG. 6 is a schematic perspective view of a mounting arrangement according to a second embodiment of the present disclosure, according to an embodiment of the present disclosure; and

FIG. 7 is an illustration of a kinematic behavior of a coupling element configured as a rod link, according to an embodiment of the present disclosure.

### DETAILED DESCRIPTION

A first aspect of the present disclosure relates to a mounting arrangement for a wind turbine for mounting a drive train on a tower of the wind turbine. The wind turbine may have a rotor. The rotor may be configured to convert wind energy into rotational mechanical energy and introduce the same into the drive train. The wind turbine may have a tower and a nacelle accommodating and supporting at least portions of the drive train. The nacelle may be mounted on a top end of the tower. The nacelle may be rotatably mounted on the tower. The nacelle may be rotatable about a vertical yaw axis to perform a yaw movement of the nacelle and thus of the rotor shaft relative to the tower. The wind turbine may have a yaw bearing to provide yaw movement. The yaw movement may be used to align the nacelle or the drive train in a horizontal plane relative to the wind, for example, in order to achieve a desired angle of attack to the wind direction. A bottom end of the tower may be anchored to a ground. Alternatively, the bottom end of the tower may be mounted on an offshore wind turbine platform.

The drive train may include a generator to convert wind energy into electrical energy. The rotor may be connected to the generator, for example, via a rotor shaft of the drive train. The rotor may have a plurality of rotor blades, for example three rotor blades. The drive train may include a hub via which the rotor is coupled to the rotor shaft. The hub may be configured to adjust an angle of attack of the rotor blades. The drive train may include a gearbox disposed in a torque flow between the rotor and the generator. The generator may be configured to use the rotation of the rotor shaft or the rotation of an output of the gearbox for power generation. The gearbox may be configured to convert a rotational speed of the rotor shaft into another, for example higher, rotational speed for driving the generator. The rotational speed of the rotor shaft during operation may be, for example, between 2 rpm and 30 rpm, for example between 5 rpm and 20 rpm. The rotational speed for driving the generator during operation may be, for example, between 500 rpm and 3000 rpm, for example between 900 rpm and 2000 rpm. An input of the gearbox may be mechanically operatively connected to the rotor, and the output of the gearbox may be mechanically operatively connected, for example, to the generator. The gearbox may be configured to transmit a torque from the rotor shaft to the generator. The torque at the input of the gearbox during operation may be between 500,000 Nm and 15,000,000 Nm, for example between 3,000,000 Nm and 10,000,000 Nm. The drive train may also include ancillary equipment. The ancillary equipment may be configured to control parameters of the remainder of the drive train and physical variables of the wind turbine. The ancillary equipment may include, for example, a heating system, a cooling system, an alignment system for the nacelle, an adjustment system for the hub, and/or converter systems such as inverters for the generated electrical energy.

The mounting arrangement may be configured to support at least some kinematic degrees of freedom of the drive train. The kinematic degrees of freedom may include three translations and three rotations. The mounting arrangement may be configured to support one, multiple, or all degrees of freedom of the drive train or of portions thereof. Depending on the design of the mounting arrangement, another mounting arrangement may be provided which locks remaining degrees of freedom and/or supports portions of the drive train that are not supported by the mounting arrangement. In principle, it may be necessary to hold fixed five of the six degrees of freedom of the rotor shaft in order to operate the wind turbine. A rotational degree of freedom of the rotor shaft can remain free during operation in order to allow rotation of the rotor shaft and the associated introduction of torque for energy generation. The rotation of the rotor shaft can produce a reaction moment in the generator. The reaction moment in the generator can be supported by the mounting arrangement. The drive train may also include a braking device capable of braking the rotation of the rotor shaft, for example in case of excessive wind or for maintenance work.

The mounting arrangement includes a bedplate that can be mounted on the tower. The bedplate may be rotatably mounted on the tower, for example directly on the tower or indirectly via a yaw bearing. The bedplate may be configured to provide attachment points for the mounting arrangement for the introduction of forces and/or moments. The attachment points may include rigid connections and/or articulated connections. The bedplate may be configured, for example, as an at least partially annular element. The bedplate may also be configured as a shell element. The bedplate may have a passage for the rotor shaft at a rotor end.

The mounting arrangement includes a main bearing unit for rotatably supporting a rotor shaft of the drive train and for supporting radial forces of the rotor shaft. The main bearing unit may be disposed at a rotor-side end portion of the nacelle, for example near the hub. The main bearing unit may be formed integrally with the bedplate or mounted thereto. The main bearing unit may include a main bearing that rotatably supports the rotor shaft. The main bearing may include a rolling-element bearing and/or a sliding bearing.

With respect to a rotor shaft axis, the radial forces have components in a horizontal transverse direction perpendicular to the rotor shaft axis and in a vertical direction perpendicular to the rotor shaft axis and to the transverse direction. The rotor shaft axis may be a central axis of the rotor shaft. Under certain circumstances, the rotor shaft axis may not be straight, but may follow a bend in the rotor shaft. The radial forces of the rotor shaft may include, for example, a weight force of the rotor, the weight force of the rotor shaft, and/or operating forces due to the rotation of the rotor shaft. The main bearing unit may further be configured to introduce pitching moments about an axis extending in the transverse direction and/or yaw moments about an axis extending in the vertical direction into the bedplate. The main bearing unit may further be configured to allow axial displacements along the rotor shaft axis. The main bearing may, for example, be configured as a pure radial bearing, for example as a cylindrical sliding bearing. Alternatively, the main bearing unit may at least partially support axial forces of the rotor shaft.

The mounting arrangement includes a support housing for accommodating and supporting components of the drive train. The support housing may be configured to accommodate and support only portions of the drive train or the entire drive train. For example, the support housing may support only the gearbox, only the generator, or both the gearbox and the generator. The support housing may also be configured to support rotatable elements. The rotatable elements may include, for example, the rotor shaft or transmission elements such as gears. The components and/or rotatable elements accommodated and supported in the support housing may introduce forces and/or moments into the support housing.

The mounting arrangement includes an auxiliary bearing unit for supporting the support housing. The auxiliary bearing unit may be configured to absorb and support a torsional moment about the rotor shaft axis, which is applied by the drive train to the support housing. Alternatively or additionally, the auxiliary bearing unit may be configured to absorb and support axial forces in the direction of the rotor shaft axis. The auxiliary bearing unit may also be configured to introduce further forces, such as weight forces and forces that are not fully supported by the main bearing unit, into the bedplate.

The mounting arrangement includes two or more coupling elements for supporting at least one of the main bearing unit and the auxiliary bearing unit on the bedplate. Each coupling element is configured as a rod link which is rotatably mounted at both of its ends and has a greater rigidity in its longitudinal direction than transverse to its longitudinal direction. The rotatable mounting of the rod link may be implemented using a fixed rotary joint. Examples of such joints may include a ball joint, a universal joint, a homokinetic joint, and a pivot joint. The ball joint may have three free rotational degrees of freedom. The universal joint and the homokinetic joint may have two free rotational degrees of freedom and one locked rotational degree of freedom. The pivot joint may have one free rotational degree of freedom and two locked rotational degrees of freedom.

The rotatable mounting to the base plate can be direct or indirect. In the case of direct mounting, the coupling element may be mounted directly on the bedplate. In the case of indirect mounting, the coupling element may be mounted on a further component that is mounted on the bedplate. An example of such a further component is a support element described later.

The coupling element configured as a rod link may be an elongated element and have its greatest extent in its longitudinal direction. The rod link may have a first end and a second end. The rod link may extend lengthwise from the first end to the second end. The rod link may be configured such that holding one end stationary provides a guide curve for the other end. If the length of the rod link is constant, the guide curve may be a circle with the length as a radius. If both ends are rotatably mounted with respect to three rotational degrees of freedom, the rod link can only lock a translational degree of freedom in its longitudinal direction; all other degrees of freedom are free. Thus, a rod link used in a kinematic system is capable of locking one degree of freedom of the kinematic system. Up to three further degrees of freedom can be locked per coupling element by the mounting of the coupling element configured as a rod link.

The rod link may have a degree of damping. The degree of damping may be provided via passive or active damping elements. The degree of damping may serve to suppress vibrations. The rod link may be configured to apply an actuator force in its longitudinal direction. The actuator force may be provided by an actuator. The actuator force may serve to cause a movement in the kinematic system via a change in length of the rod link

Due to its configuration as a rod link, each coupling element is able to lock one degree of freedom. If two such coupling elements are disposed substantially parallel and along the same direction, for example in one plane, it is possible to support two interrelated degrees of freedom, for example a displacement and a torsion transverse to the displacement. The greater the coincidence of the orientations of the two coupling elements, the lower are the parasitic interactions with other degrees of freedom occurring, for example in the form of parasitic forces. Nevertheless, the supporting of two degrees of freedom can also be accomplished by a pair of coupling elements that are not disposed in one plane, but deviate from it. Parasitic forces generated thereby can be absorbed in another way, for example by further coupling elements and/or by further mounting devices.

A kinematic system of the main bearing unit and auxiliary bearing unit loaded by the rotor shaft includes a total of twelve degrees of freedom, namely six for each of the main bearing unit and the auxiliary bearing unit. In order to provide a statically determinate system, all twelve degrees of freedom may be locked. In one embodiment, the main bearing unit may be supported via at least one pair of coupling elements. Alternatively or additionally, the auxiliary bearing unit may be supported via at least one pair of coupling elements. In one embodiment, the main bearing unit may be supported via three pairs of coupling elements. In such an embodiment, all six degrees of freedom of the main bearing unit are supported via coupling elements. Similarly, in one embodiment, the auxiliary bearing unit may be supported via three pairs of coupling elements with respect to all six degrees of freedom. Consequently, the kinematic system can be entirely mounted in a statically determinate manner by a maximum of twelve coupling elements. Depending on the number of coupling elements and of the thereby locked degrees of freedom, the mounting arrangement may also include further mounting devices other than the coupling elements to lock the degrees of freedom lacking for static determinacy. For example, the degrees of freedom lacking for static determinacy may be rigidly and/or partially articulatedly supported by corresponding mounting devices. Such support may be provided, for example, on the bedplate.

The mounting arrangement according to the first aspect provides a mounting arrangement that includes at least two coupling elements for supporting the main bearing unit and/or the auxiliary bearing unit. Thus, at least one degree of freedom of the main bearing unit and/or at least one degree of freedom of the auxiliary bearing unit can be locked by a coupling element configured as a rod link. Since the rod link locks one to three degrees of freedom depending on how it is mounted, a suitable number of degrees of freedom can be supported in a simple manner. Degrees of freedom having high loads, for example, can be supported by a coupling element with only one locked degree of freedom in order to isolate the high load in the longitudinal direction of the coupling element. Degrees of freedom having low loads, for example, can be supported by a coupling element with three locked degrees of freedom. Accordingly, the coupling elements allow for a flexible design of force transmission paths and means for spatial guidance of the components. This allows for maximizing rigidities in the direction of a high load and minimizing rigidities in the direction of a low load. Naturally, rigidity is provided through selective use of materials. The mounting arrangement according to the first aspect therefore allows the use of materials to be optimized in view of the loads in order to ensure effective support. Accordingly, the mounting arrangement of the first aspect achieves high rigidities while keeping the weight low.

In one embodiment, one of the main bearing unit and the auxiliary bearing unit is mounted on the bedplate via a pair of first coupling elements extending in opposite directions along the transverse direction. In the present disclosure, the terms “first,” “second,” and “third” are used only for easier reference, and their order is arbitrary. Unless otherwise specified, the term “first” refers to an extent in the transverse direction, the term “second” refers to an extent in the vertical direction, and the term “third” refers to an extent in the direction of the rotor shaft axis. Regardless of the term used, all or only some of these elements may be provided. For example, a second element may be provided without the first and third elements. This would correspond to a mounting arrangement having only one pair of coupling elements extending in the vertical direction. Some elements may be combined. For example, an element may have both the properties of the first element and the properties of the second element. This would correspond to a mounting arrangement having a pair of coupling elements that extend in both the transverse direction and the vertical direction and thus function as a combined first and second coupling element. By providing a pair of coupling elements in the transverse direction for supporting one of the main bearing unit and the auxiliary bearing unit, both a displacement in the transverse direction and a rotation that is not in the same plane as the coupling elements can be locked for the one of the main bearing unit and the auxiliary bearing unit. Thus, reaction forces of one of the main bearing unit and the auxiliary bearing unit, which arise due to a yaw moment on the rotor shaft, can be effectively supported. In one embodiment, both the main bearing unit and the auxiliary bearing unit may be supported via a pair of first coupling elements.

In one embodiment, one of the first coupling elements is rotatably mounted at a lower end portion of one of the main bearing unit and the auxiliary bearing unit. This allows the first coupling element to effectively absorb forces in the transverse direction and introduce them over a short distance into the bedplate. In one embodiment, both of the first coupling elements may be mounted in this manner.

In one embodiment, one of the main bearing unit and the auxiliary bearing unit is mounted on the bedplate via a pair of second coupling elements which are disposed in a plane perpendicular to the rotor shaft axis on opposite sides of the rotor shaft axis and extend in the vertical direction. This allows both vertical displacement and rotation about the rotor shaft axis to be locked for one of the main bearing unit and the auxiliary bearing unit. Therefore, forces in the vertical direction and also reaction forces from the torsional moment of the rotor shaft can be effectively supported. In one embodiment, the second coupling elements may be configured to lock a second degree of freedom. For example, the second coupling elements may be mounted via a pivot joint to also lock displacement in the direction of the rotor shaft axis. In one embodiment, both the main bearing unit and the auxiliary bearing unit may be supported via a respective pair of second coupling elements.

In one embodiment, one of the second coupling elements is mounted on the bedplate at a location that overlaps an attachment surface of the bedplate to the tower in the vertical direction. The attachment surface may be, for example, a contact surface of the bedplate to the tower or the yaw bearing. The attachment surface may substantially correspond to the surface of a top-end wall of the tower. Due to the design of this embodiment, the second coupling element can effectively absorb forces in the vertical direction and introduce them over a short distance via the bedplate into the tower. In one embodiment, both of the second coupling elements may be mounted in this manner.

In one embodiment, one of the main bearing unit and the auxiliary bearing unit is mounted on the bedplate via a pair of third coupling elements which are disposed on opposite sides of the rotor shaft axis and extend in the direction of the rotor shaft axis. This allows both displacement in the direction of the rotor shaft axis and rotation about an axis extending in the transverse direction to be locked for one of the main bearing unit and the auxiliary bearing unit. Thus, reaction forces of one of the main bearing unit and the auxiliary bearing unit, which are caused by the axial forces of the rotor shaft and a pitching moment on the rotor shaft, can be effectively supported. In one embodiment, only the auxiliary bearing unit may absorb axial forces of the rotor shaft and support them via a pair of third coupling elements. In one embodiment, only the main bearing unit may absorb axial forces of the rotor shaft and support them via a pair of third coupling elements. In one embodiment, both the main bearing unit and the auxiliary bearing unit may partially absorb axial forces of the rotor shaft. In such an embodiment, the main bearing unit and the auxiliary bearing unit may support the respective axial forces, for example, via a pair of third coupling elements.

In one embodiment, one of the third coupling elements is rotatably mounted at an end portion in the vertical direction of one of the main bearing unit and the auxiliary bearing unit. In one embodiment, both of the third coupling elements may be mounted at an end portion in the vertical direction. For example, one of the third coupling elements may be rotatably mounted at an upper end portion and the other of the third coupling elements may be rotatably mounted at a lower end portion. This ensures effective support of the pitching moment.

In one embodiment, each of the third coupling elements is mounted on the bedplate via a support element. The support element is rotatable about a first axis relative to the bedplate. The support housing is rotatable about a second axis relative to the support element. The first axis and the second axis are perpendicular to each other. Thus, from a kinematic point of view, a cardanic suspension is provided for mounting the auxiliary bearing unit on the bedplate via the support element. The cardanic suspension allows free rotation of the support housing about the two axes. This allows the support housing to follow the bending of the rotor shaft without generating additional reaction forces.

In one embodiment, the support element is mounted on the bedplate via at least one of a lateral coupling element, a vertical coupling element, and an oblique coupling element. The lateral coupling element may extend in the transverse direction. The vertical coupling element may extend in the vertical direction. The oblique coupling element may extend in a direction which has components in the direction of the rotor shaft axis, in the transverse direction, and in the vertical direction. This embodiment provides a simple mounting for the support element. In one embodiment, all of the lateral coupling element, the vertical coupling element, and the oblique coupling element may be provided. Thus, a fixed support element can be provided in a simple manner. In one embodiment, the vertical coupling element may be mounted on the bedplate via a further support structure. In one embodiment, the support housing may be mounted on the further support structure via a further coupling element. The further coupling element may extend in the vertical direction toward the further support structure. Thus, the further coupling element may further support the support housing against a bending of the rotor shaft and against a weight force of masses accommodated in the support housing. In one embodiment, the rigidity of the further coupling element may be adjusted so as to eliminate parasitic forces arising in gear sets of the gearbox and/or of the generator, for example, due to the weight force.

In one embodiment, one of the coupling elements is configured as an actuator for controlling an orientation of the rotor shaft. For example, a coupling element which is rotationally mounted on the main bearing unit off a yaw axis of the rotor shaft and extends in the transverse direction may be configured as an actuator. In this case, a change in length of the coupling element causes a displacement of the main bearing unit in the transverse direction, which corresponds to a circumferential direction of the yaw axis. As a result, the rotor shaft performs a yaw movement about the yaw axis, and its orientation relative to the bedplate changes. In one embodiment, a plurality of coupling elements, for example two coupling elements of a pair, may be configured as actuators. In one embodiment, all coupling elements may be configured as actuators.

In one embodiment, one of the coupling elements is made electrically insulating between its ends. This can prevent transmission of undesired currents, for example leakage currents, from the drive train via the coupling element into the bedplate. In addition, the coupling element can be prevented from being mechanically weakened or damaged by a very high current caused, for example, by a lightning strike. In one embodiment, a plurality of coupling elements, for example two coupling elements of a pair, may be made electrically insulating. In one embodiment, all coupling elements may be made electrically insulating.

A second aspect of the present disclosure relates to a wind turbine that includes the mounting arrangement according to the first aspect. The wind turbine may be configured, for example, to generate electricity. The wind turbine includes a drive train, a tower, and the mounting arrangement of the first aspect. The mounting arrangement is mounted on a top of the tower. For example, a bedplate of the mounting arrangement may be mounted on the top of the tower via a yaw bearing. The respective advantages and further features can be inferred from the description of the first aspect. Embodiments of the first aspect also form embodiments of the second inventive aspect and vice versa.

In one embodiment, one of the second coupling elements is mounted on the bedplate at a location that overlaps a top-end wall of the tower in the vertical direction. As a result, forces from the main bearing unit and/or the auxiliary bearing unit are introduced into the tower over a short distance and with high rigidity. Thus, the material use and weight are minimized with a simple design.

In one embodiment, the drive train includes a rotor having at least two rotor blades and a generator. The rotor is mechanically operatively connected to the generator via the rotor shaft. In one embodiment, the drive train includes a gearbox which is disposed in a torque flow between the rotor shaft and the generator.

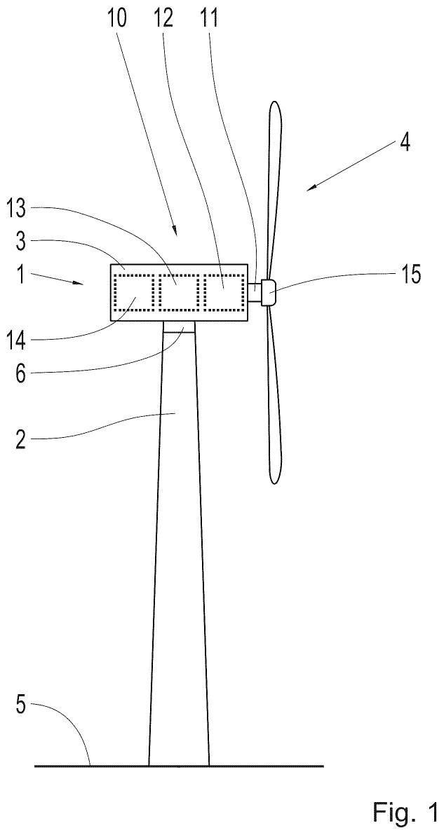

FIG. 1 schematically illustrates a horizontal-type wind turbine 1. Wind turbine 1 includes a nacelle 3, which is rotatably mounted to a top end of a tower 2 via a yaw bearing 6. A bottom end of tower 2 is anchored to a ground 5. Nacelle 3 accommodates a drive train 10 including a rotor shaft 11, a gearbox 12, a generator 13, ancillary equipment 14, and a hub 15. A rotor 4 of wind turbine 1 is mechanically operatively connected to generator 13 via hub 15, rotor shaft 11, and gearbox 12. Ancillary equipment 14 may include devices for controlling the temperature of drive train 10, devices for converting electrical power, devices for adjusting hub 15, and devices for aligning nacelle 3 via yaw bearing 6. Wind turbine 1 further includes a mounting arrangement for supporting portions of a drive train 10.

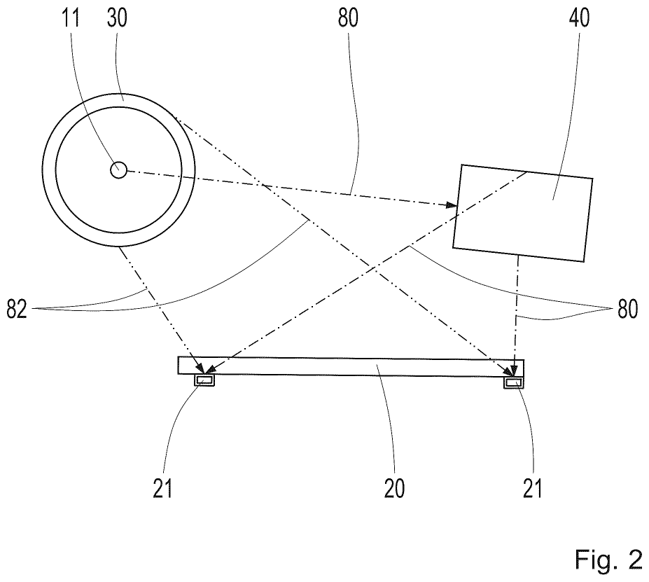

FIG. 2 illustrates of a basic principle for supporting forces and moments of wind turbine 1. Wind turbine 1 includes the drive train 10 including rotor shaft 11. Forces and torques are applied to rotor shaft 11 via rotor 4. These forces and torques may include, for example, a torsional moment about a rotor shaft axis 70 of rotor shaft 11 as well as other rotor shaft loads. The other rotor shaft loads may include, for example, axial and radial forces as well as moments about a yaw axis and about a transverse axis. The present disclosure provides that two separate paths are provided to support these forces and moments, as illustrated in the diagrammatic sketch diagram in FIG. 2. Rotor shaft 11 is mounted in a main bearing unit 30. Main bearing unit 30 is configured to freely allow at least rotation of rotor shaft 11 and to absorb some or all of the other rotor shaft loads. The other rotor shaft loads absorbed by main bearing unit 30 are introduced via a support 82 into a bedplate 20, which is mounted on tower 2 via one or more bedplate bearings 21. In contrast, the torsional moment from rotor shaft 11 is supported on an auxiliary bearing unit 40. Auxiliary bearing unit 40 is supported on bedplate 20 for the transmission of the torsional moment, so that the torsional moment is supported 80 via auxiliary bearing unit 40 and bedplate 20 on bedplate bearings 21. This basic principle separates the paths for supporting the torsional moment and for supporting other rotor shaft loads. It should be noted that some of the other rotor shaft loads may also be supported via auxiliary bearing unit 40 on bedplate 20. An example of such a support will be described later with reference to the embodiments.

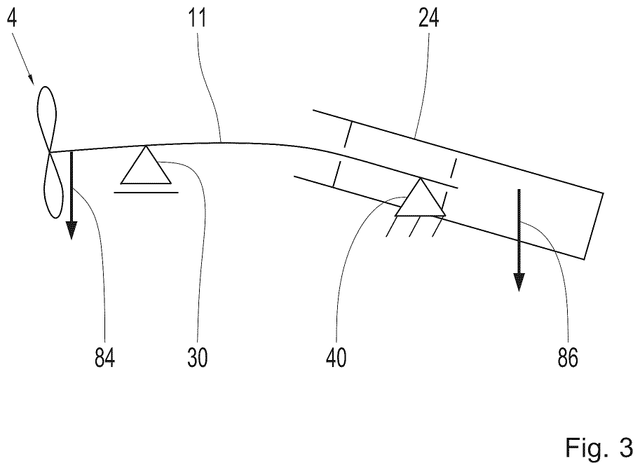

FIG. 3 illustrates a bending of rotor shaft 11 of wind turbine 1. At its end adjacent rotor 4, rotor shaft 11 is supported via main bearing unit 30, which is shown here only schematically. At its end adjacent support housing 24, which accommodates portions of the drive train, rotor shaft 11 is supported via auxiliary bearing unit 40, which is shown here only schematically. A weight force 84 of rotor 4 and a weight force 86 of support housing 24 and the components accommodated therein act on rotor shaft 11 under the influence of gravity. Under the influence of these weight forces 84, 86, rotor shaft 11 may bend in the direction of gravity, as shown exaggeratedly in FIG. 3. The present disclosure provides for enabling support housing 24 to follow the bending of shaft 11 in order to reduce the reaction forces to be supported, and to accomplish this by means of the mounting arrangement according to the embodiments, which will be described in detail later.

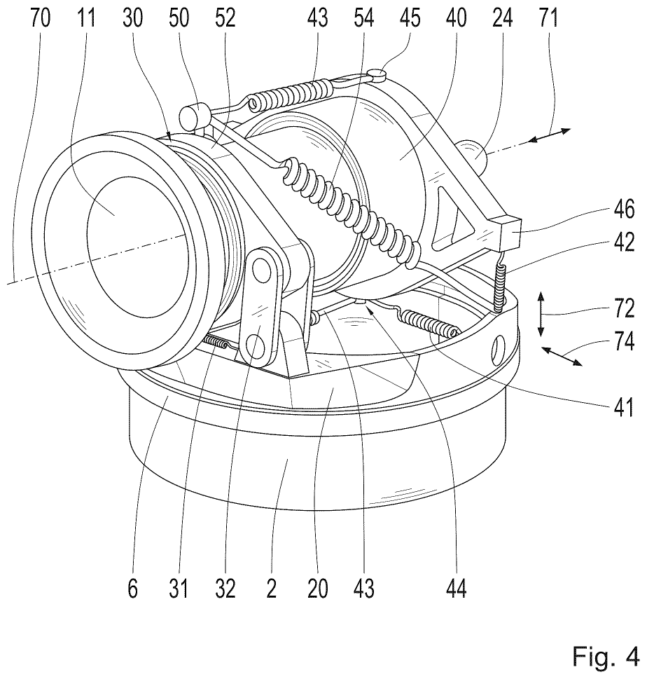

FIG. 4 schematically shows a mounting arrangement for the wind turbine 1 of FIG. 1. The mounting arrangement includes a bedplate 20, which is mounted on tower 2 via gear bearing 6. More specifically, the bedplate is joined to yaw bearing 6 via a lower attachment surface. The attachment surface is located between yaw bearing 6 and bedplate 20 and is not visible in the figure. The attachment surface substantially corresponds to the surface of a top-end wall of tower 2.

The mounting arrangement includes a main bearing unit 30, an auxiliary bearing unit 40, and a support housing 24. Main bearing unit 30 is configured to rotatably support rotor shaft 11. Main bearing unit 30 is further configured to support radial forces and yaw moments of rotor shaft 11. The radial forces refer to forces radial to a direction 71 of a rotor shaft axis 70. With reference to main bearing unit 30, the radial forces of rotor shaft 11 have components in a transverse direction 74 and in a vertical direction 72. Transverse direction 74 is a direction that is perpendicular to rotor shaft axis 70 and direction 71. Vertical direction 72 is a direction that is perpendicular to rotor shaft axis 70 and direction 71 and perpendicular to transverse direction 74. A yaw moment is a moment about a yaw axis extending in vertical direction 72. Main bearing unit 30 is mounted on bedplate 20 via coupling elements 31, 32, which will be described later.

Auxiliary bearing unit 40 is configured to support housing 24. In the present case, support housing 24 is configured to accommodate and support gearbox 12, generator 13, and ancillary equipment 14 of drive train 10. The reaction forces from the mounting of gearbox 12, generator 13, and ancillary equipment 14 are introduced into auxiliary bearing unit 40 via support housing 24. For this purpose, support housing 24 is attached (in this case, bolted) to auxiliary bearing unit 40. In FIG. 4, support housing 24 is shown in simplified form as a point mass. Auxiliary bearing unit 40 is mounted on bedplate 20 via coupling elements 41, 42, which will be described later.

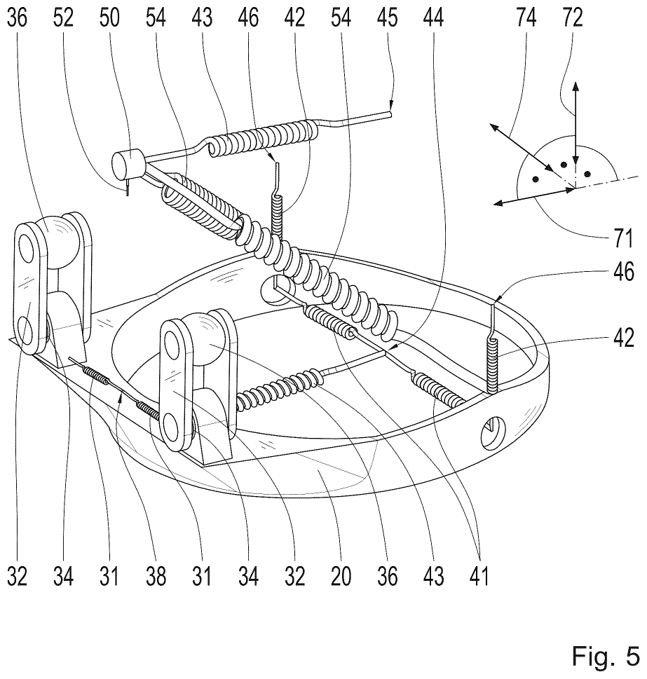

In this first embodiment, an assembly including rotor shaft 11, main bearing unit 30, and auxiliary bearing unit 40 is mounted on bedplate 20 via the coupling elements 31, 32, 41, 42, 43 with respect to all degrees of freedom. This will now be described with reference to FIG. 4 and FIG. 5. The mounting arrangement includes two first coupling elements 31 of main bearing unit 30. The two first coupling elements 31 of main bearing unit 30 extend from a lower end portion of main bearing unit 30 in opposite directions along transverse direction 74. One end of each of first coupling elements 31 of main bearing unit 30, which end is close to the main bearing unit, is rotatably mounted at a lower end portion 38 of main bearing unit 30 (see FIG. 5). In the present case, mounting is via a ball joint. One end of each of first coupling elements 31 of main bearing unit 30, which end is remote from the main bearing unit, is rotatably mounted on bedplate 20, in this case via a ball joint. Thus, the two first coupling elements 31 of main bearing unit 30 are capable of introducing forces in transverse direction 74 from main bearing unit 30 into bedplate 20.

The mounting arrangement includes two second coupling elements 32 of main bearing unit 30. The two second coupling elements 32 of main bearing unit 30 are disposed at the same level of rotor shaft axis 70, i.e., in a plane perpendicular to rotor shaft axis 70. The two second coupling elements 32 of main bearing unit 30 extend in vertical direction 72. An end close to the bedplate, namely a lower end in FIG. 5, of each of the two second coupling elements 32 of main bearing unit 30 is rotatably mounted on bedplate 20 by means of a pivot joint 34. An end remote from the bedplate, namely an upper end in FIG. 5, of each of second coupling elements 32 of main bearing unit 30 is rotatably mounted on main bearing unit 30 via a ball joint 36 (see FIG. 5). Thus, the two second coupling elements 32 of main bearing unit 30 are capable of introducing forces in vertical direction 72 from main bearing unit 30 into bedplate 20. Since the respective end of the two coupling elements 32 of main bearing unit 30 that is close to the bedplate is mounted on bedplate 20 via pivot joint 34, the two second coupling elements 32 of main bearing unit 30 are further capable of introducing axial forces from main bearing unit 30 into bedplate 20. It should be noted that the rigidity of the two second coupling elements 32 of main bearing unit 30 in their respective longitudinal direction, namely vertical direction 72, is significantly lower than their rigidity in their longitudinal direction because they are configured as rod links. Thus, the rigidity for absorbing axial forces in the direction of rotor shaft axis 70 is lower than that for absorbing forces in vertical direction 72. However, in the mounting arrangement of the first embodiment, there is no need for high rigidity in direction 71 of rotor shaft axis 70 since main bearing unit 30 does not absorb significant axial forces from rotor shaft 11.

The mounting arrangement includes two first coupling elements 41 of auxiliary bearing unit 40. The two first coupling elements 41 of auxiliary bearing unit 40 extend from a lower end portion of auxiliary bearing unit 40 in opposite directions along transverse direction 74. One end of each of first coupling elements 41 of auxiliary bearing unit 40, which end is close to the auxiliary bearing unit, is rotatably mounted at a lower end portion 44 of auxiliary bearing unit 40 (see FIG. 5). In the present case, mounting is via a ball joint. One end of each of first coupling elements 41 of auxiliary bearing unit 40, which end is remote from the auxiliary bearing unit, is rotatably mounted on bedplate 20, in this case via a ball joint. Thus, the two first coupling elements 41 of auxiliary bearing unit 40 are capable of introducing forces in transverse direction 74 from auxiliary bearing unit 40 into bedplate 20.

The mounting arrangement includes two second coupling elements 42 of auxiliary bearing unit 40. The two second coupling elements 42 of auxiliary bearing unit 40 are disposed at the same level of rotor shaft axis 70, i.e., in a plane perpendicular to rotor shaft axis 70. The two second coupling elements 42 of auxiliary bearing unit 40 extend in vertical direction 72. An end close to the bedplate, namely a lower end in FIG. 5, of each of the two second coupling elements 42 of auxiliary bearing unit 40 is rotatably mounted on bedplate 20, in this case via a ball joint. An end remote from the bedplate, namely an upper end in FIG. 5, of each of the second coupling elements 42 of auxiliary bearing unit 40 is rotatably mounted on auxiliary bearing unit 40 a lateral end portion 46 of auxiliary bearing unit 40 (see FIG. 4), in this case via a ball joint. Thus, the two second coupling elements 42 of auxiliary bearing unit 40 are capable of introducing forces in vertical direction 72 from auxiliary bearing unit 40 into bedplate 20.

The mounting arrangement of the first embodiment includes two third coupling elements 43 of auxiliary bearing unit 40. In the present case, the two third coupling elements 43 are disposed in a vertical plane that is normal to transverse direction 74 and contains rotor axis 70. More specifically, the two third coupling elements 43 of auxiliary bearing unit 40 are disposed above and below the rotor shaft axis. The two third coupling elements 43 of auxiliary bearing unit 40 extend in direction 71 of rotor shaft axis 70. An end of one of third coupling elements 43 of auxiliary bearing unit 40, namely the lower coupling element 43 in FIG. 5, which end is close to the auxiliary bearing unit, is rotatably mounted at lower end portion 44 of auxiliary bearing unit 40, in this case via a ball joint. An end of one of third coupling elements 43 of auxiliary bearing unit 40, which end is remote from the auxiliary bearing unit, is rotatably mounted on bedplate 20, in this case via a ball joint. An end of the other of second coupling elements 42 of auxiliary bearing unit 40, namely of upper coupling element 43, which end is close to the auxiliary bearing unit, is rotatably mounted at an upper end portion 45 of auxiliary bearing unit 40, in this case via a ball joint. An end of the other of third coupling elements 43, which end is remote from the auxiliary bearing unit, is in this case rotatably mounted on a support element 50 of the mounting arrangement, in this case via a ball joint. Thus, in the first embodiment, the two third coupling elements 43 of auxiliary bearing unit 40 are capable of introducing axial forces of rotor shaft 11 from auxiliary bearing unit 40 into support element 50.

Support element 50 is mounted via two oblique coupling elements 54 with respect to displacements in direction 71 of rotor shaft axis 70 and in transverse direction 74. Oblique coupling elements 54 extend in a direction which has components in direction 71 of rotor shaft axis 70, in transverse direction 74, and in vertical direction 72. Oblique coupling elements 54 are rotatably mounted at both ends, in this case via ball joints. Support element 50 is mounted via a vertical coupling element 52 with respect to vertical displacements. Vertical coupling element 52 extends in vertical direction 72 from support element 50 to main bearing unit 30. Both ends of vertical coupling element 52 are rotatably mounted, in this case via ball joints. Support element 50 is mounted in a fixed position by vertical coupling element 52 and oblique coupling elements 54. Therefore, support member 50 can function as a fixed support point for an end of third coupling element 43 of auxiliary bearing unit 40.

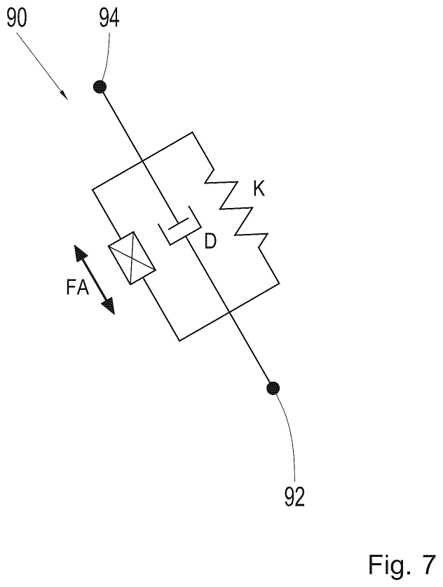

In the present case, each of the coupling elements 31, 32, 41, 54, 43, 52, 42 described above is configured as a rod link. The kinematic behavior of such a rod link 90 will now be described with reference to FIG. 7. Rod link 90 is an elongated element and has a first end 92 and a second end 94. Rod link 90 extends lengthwise from first end 92 to second end 94. If one of the ends is held stationary, the length of rod link 90 determines a guide curve for the other end. If both ends 92, 94 are rotatably mounted with respect to three rotational degrees of freedom, rod link 90 can only lock a translational degree of freedom in its longitudinal direction; all other degrees of freedom are free. Thus, a rod link 90 used in a kinematic system is capable of locking one degree of freedom of the kinematic system. In a real kinematic system, rod link 90 is not ideally rigid, but has a rigidity K. Rod link 90 optionally has a degree of damping D and an actuator force FA. Degree of damping D may be provided by damping elements and may serve to suppress vibrations. Actuator force FA may be provided by an actuator and may serve to cause a movement in the kinematic system via a change in length of rod link 90.

In the mounting arrangement according to the first embodiment, a total of five pairs of coupling elements are provided. Since the two first coupling elements 31 of main bearing unit 30 are mounted by pivot joints, they are capable of locking an additional degree of freedom. Thus, the two first coupling elements 31 of main bearing unit 30 can lock a total of four degrees of freedom of the system. The two second coupling elements 32 of main bearing unit 30 as well as the two first coupling elements 41, the two second coupling elements 42, and the two third coupling elements 43 of auxiliary bearing unit 40 are mounted at both ends via ball joints and are thus capable of locking one degree of freedom in each case. In summary, therefore, four degrees of freedom are locked by the two first coupling elements 31, and eight degrees of freedom are locked by the remaining coupling elements 32, 41, 42, 43. The kinematic system including main bearing unit 30 and auxiliary bearing unit 40 also has a total of twelve degrees of freedom, namely three translational and three rotational degrees of freedom per bearing unit 30, 40. Thus, the kinematic system according to the first embodiment is statically determinate.

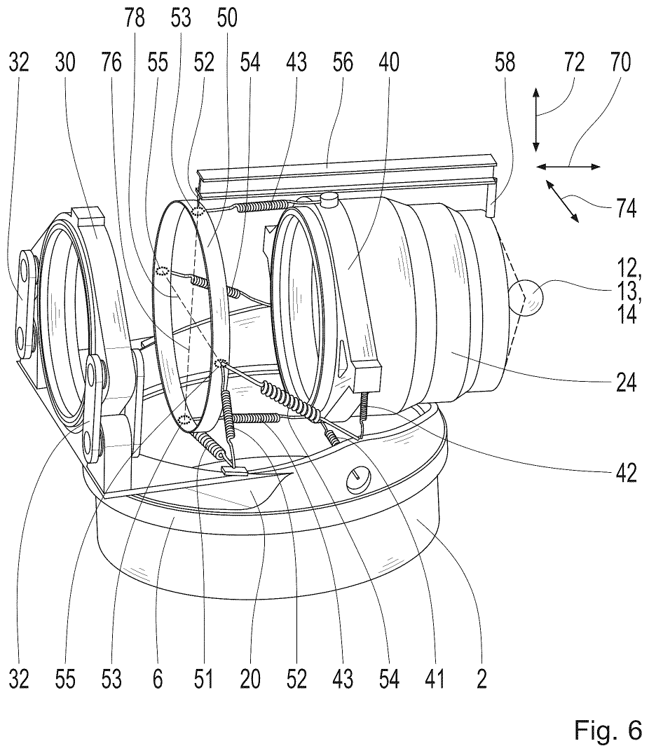

FIG. 6 schematically shows a mounting arrangement according to a second embodiment. Only differences from the first embodiment of FIGS. 4 and 5 will be described. In the present case, support element 50 is configured as an annular component that surrounds rotor shaft 11. Support element 50 is rotatable about a first axis 76 relative to bedplate 20. Auxiliary bearing unit 40 is rotatably mounted relative to support element 50 about a second axis 78 which, in the present case, extends in transverse direction 74. The first axis and the second axis are perpendicular to each other. Thus, from a kinematic point of view, a cardanic suspension is provided for mounting auxiliary bearing unit on bedplate 20 via support element 50.

In the present case, first axis 76 extends in vertical direction 72, and second axis 78 extends in transverse direction 74. First axis 76 extends between two first coupling points 53. The two first coupling points 53 are located at a lower end portion and an upper end portion of support element 50. The mounting arrangement includes two lateral coupling elements 51 extending in opposite directions in transverse direction 74. Lateral coupling elements 51 are configured as rod links. One end of each of the two lateral coupling elements 51 is rotatably mounted at one of the first coupling points 53, namely the lower one in FIG. 6. The other end of each of lateral coupling elements 51 is rotatably mounted on bedplate 20, in this case via a ball joint. The other first coupling point 53 is mounted on a support structure 56 via a vertical coupling element 52. The support structure 56 is mounted in a fixed position with respect to the bedplate 20 (not shown). Vertical coupling element 52 is configured as a rod link and extends in transverse direction 72. One end of vertical coupling element 52 is rotatably mounted at the other first coupling point 53, in this case via a ball joint. The other end of vertical coupling element 52 is rotatably mounted on support structure 56, in this case via a ball joint.

Second axis 78 extends between two second coupling points 55. The two second coupling points 55 are each located on lateral end portions of support element 50. Two further vertical coupling elements 52 connect the two second coupling points 55 to bedplate 20. The two further vertical coupling elements 52 are disposed in a plane perpendicular to the rotor shaft axis and extend in vertical direction 72. The two further vertical coupling elements 52 are configured as rod links. One end of each of the two further vertical coupling elements 52 is rotatably mounted on support element 50 at a second coupling point 55, in this case via a ball joint. The respective other end of each of the two further vertical coupling elements 52 is rotatably mounted on bedplate 20, in this case via a ball joint.

Support element 50 is further mounted via two oblique coupling elements 54 of the mounting arrangement. The two oblique coupling elements 54 extend in a direction which has components both in direction 71 of rotor shaft axis 70 and in vertical direction 72 and transverse direction 74. One end of each oblique coupling element is rotatably mounted at a respective second coupling point 55, in this case via a ball joint. The other end is rotatably mounted on bedplate 20, in this case via a ball joint.

FIG. 6 shows support housing 24 schematically. The components of the drive train 10 accommodated therein, namely gearbox 12, generator 13, and ancillary equipment 14, are shown as a point mass kinematically coupled to support housing 24. Support housing 24 is mounted on support structure 56 via a further coupling element 58. Further coupling element 58 extends from an end portion of support housing 24 remote from the auxiliary bearing unit, which is also an upper end portion, in the vertical direction to support structure 56. Thus, further coupling element 58 further supports support housing 24 against a bending of rotor shaft 11 and against a weight force of the masses accommodated in support housing 24. In addition, in the present case, the rigidity of further coupling element 58 is adjusted so as to eliminate parasitic forces arising in gear sets, here planetary stages, of gearbox 12 due to the weight force.

The mounting of support element 50 in accordance with the second embodiment provides a cardanic suspension of auxiliary bearing unit 40 on bedplate 20 via support element 50. Thus, auxiliary bearing unit 40 is able to rotate about two axes to follow the bending of rotor shaft 11.

In another embodiment (not shown), instead of auxiliary bearing unit 40, as in the first embodiment of FIGS. 4 and 5, main bearing unit 30 is provided with two third coupling elements 43. Furthermore, main bearing unit 30 is configured to absorb axial forces of rotor shaft 11. The explanations regarding the mounting arrangement of the first embodiment and its two third coupling elements 43 of auxiliary bearing unit 40 apply analogously when all mentions of “auxiliary bearing unit 40,” “close to the auxiliary bearing unit” and “remote from the auxiliary bearing unit” in the context of third coupling elements 43 are replaced with “main bearing unit 30,” “close to the main bearing unit,” and “remote from the main bearing unit,” respectively. Thus, in the present embodiment, the two third coupling elements 43 of main bearing unit 30 are capable of introducing axial forces of rotor shaft 11 from main bearing unit 30 into support element 50.

While subject matter of the present disclosure has been illustrated and described in detail in the drawings and foregoing description, such illustration and description are to be considered illustrative or exemplary and not restrictive. Any statement made herein characterizing the invention is also to be considered illustrative or exemplary and not restrictive as the invention is defined by the claims. It will be understood that changes and modifications may be made, by those of ordinary skill in the art, within the scope of the following claims, which may include any combination of features from different embodiments described above.

The terms used in the claims should be construed to have the broadest reasonable interpretation consistent with the foregoing description. For example, the use of the article “a” or “the” in introducing an element should not be interpreted as being exclusive of a plurality of elements. Likewise, the recitation of “or” should be interpreted as being inclusive, such that the recitation of “A or B” is not exclusive of “A and B,” unless it is clear from the context or the foregoing description that only one of A and B is intended. Further, the recitation of “at least one of A, B and C” should be interpreted as one or more of a group of elements consisting of A, B and C, and should not be interpreted as requiring at least one of each of the listed elements A, B and C, regardless of whether A, B and C are related as categories or otherwise. Moreover, the recitation of “A, B and/or C” or “at least one of A, B or C” should be interpreted as including any singular entity from the listed elements, e.g., A, any subset from the listed elements, e.g., A and B, or the entire list of elements A, B and C.

### REFERENCE NUMERALS

1 wind turbine
2 tower
3 nacelle
4 rotor
5 ground
6 yaw bearing
10 drive train
11 rotor shaft
12 gearbox
13 generator
14 ancillary equipment
15 hub
20 bedplate
21 bedplate bearing
24 support housing
30 main bearing unit
31, 41 first coupling element
32, 42 second coupling element
34 pivot joint
40 auxiliary bearing unit
43 third coupling element
38, 44 lower end portion
45 upper end portion
46 lateral end portion
50 support element
51 lateral coupling element
52 vertical coupling element
53 first coupling point
54 oblique coupling element
55 second coupling point
56 support structure
58 further coupling element
70 rotor shaft axis
71 direction of the rotor shaft axis
72 vertical direction
74 transverse direction
76 first axis
78 second axis
80 support of the torsional moment
82 support of other rotor shaft loads
84, 86 weight force
90 rod link
92 first end
94 second end

What is claimed is:

1. A mounting arrangement for a wind turbine for mounting a drive train on a tower of the wind turbine, the mounting arrangement comprising:
a bedplate that is mounted on the tower;
a main bearing unit for rotatably supporting a rotor shaft of the drive train and for supporting radial forces of the rotor shaft, the radial forces with respect to a rotor shaft axis having components in a horizontal transverse direction perpendicular to the rotor shaft axis and in a vertical direction perpendicular to the rotor shaft axis and to the horizontal transverse direction;
a support housing for accommodating and supporting components of the drive train; and
an auxiliary bearing unit for supporting the support housing,
wherein the mounting arrangement includes two or more coupling elements for supporting at least one of the main bearing unit and the auxiliary bearing unit on the bedplate, and
wherein each coupling element is configured as a rod link which is rotatably mounted at both of its ends and has a greater rigidity in its longitudinal direction than transverse to its longitudinal direction.

2. The mounting arrangement as recited in claim 1,
wherein one of the main bearing unit and the auxiliary bearing unit is mounted on the bedplate via a pair of first coupling elements extending in opposite directions along the horizontal transverse direction.

3. The mounting arrangement as recited in claim 2,
wherein one of the first coupling elements is rotatably mounted at a lower end portion of one of the main bearing unit and the auxiliary bearing unit.

4. The mounting arrangement as recited in claim 1,
wherein one of the main bearing unit and the auxiliary bearing unit is mounted on the bedplate via a pair of second coupling elements which are disposed in a plane perpendicular to the rotor shaft axis on opposite sides of the rotor shaft axis and extend in the vertical direction.

5. The mounting arrangement as recited in claim 4,
wherein one of the second coupling elements is mounted on the bedplate at a location that overlaps an attachment surface of the bedplate to the tower in the vertical direction.

6. The mounting arrangement as recited in claim 1,
wherein one of the main bearing unit and the auxiliary bearing unit is mounted on the bedplate via a pair of third coupling elements which are disposed on opposite sides of the rotor shaft axis and extend in a direction of the rotor shaft axis.

7. The mounting arrangement as recited in claim 6,
wherein one of the third coupling elements is rotatably mounted at an end portion in the vertical direction of one of the main bearing unit and the auxiliary bearing unit.

8. The mounting arrangement as recited in claim 7,
wherein each of the third coupling elements is mounted on the bedplate via a support element, the support element being rotatable about a first axis relative to the bedplate, and the support housing being rotatable about a second axis relative to the support element, and the first axis and the second axis being perpendicular to each other.

9. The mounting arrangement as recited in claim 8,
wherein the support element is mounted on the bedplate via at least one of a lateral coupling element, a vertical coupling element, and an oblique coupling element.

10. The mounting arrangement as recited in claim 1,
wherein one of the coupling elements is configured as an actuator for controlling an orientation of the rotor shaft.

11. The mounting arrangement as recited in claim 1,
wherein one of the coupling elements is made electrically insulating between its ends.

12. A wind turbine comprising a drive train, a tower, and a mounting arrangement according to claim 1, which mounting arrangement is mounted on a top of the tower.

13. The wind turbine as recited in claim 12, having a mounting arrangement, wherein one of the main bearing unit and the auxiliary bearing unit is mounted on the bedplate via a pair of second coupling elements which are disposed in a plane perpendicular to the rotor shaft axis on opposite sides of the rotor shaft axis and extend in the vertical direction, and
wherein one of the second coupling elements is mounted on the bedplate at a location that overlaps a top-end wall of the tower in the vertical direction.
